(19) United States
(12) Patent Application Publication
(10) Pub. No.: US 2002/0043226 A1
(43) Pub. Date: Apr. 18, 2002

(54) Internal combustion engine featuring axially and opposingly arranged units

(76) Inventor: Marion Gofron, Sterling Heights, MI (US)

Correspondence Address: Douglas J. McEvoy, Gifford, Krass, Groh, Sprinkle,, Anderson & Citkowski, P.C., 280 North Old Woodward, Suite 400, Birmingham, MI, 48009, US

(21) Appl. No.: 09/982,069

(22) Filed: Oct. 17, 2001

Related U.S. Application Data
(60) Provisional application No. 60/241,062, filed on Oct. 17, 2000.

(51) Int. Cl. F02B 75/18

(52) U.S. Cl. 123/56.1

(57) ABSTRACT

An internal combustion engine consisting of one ore more individual pairs of units. Each pair of units form a separate sub-assembly and each unit is arranged in axially spaced and opposing fashion relative to one another. Each of the unit pairs further includes a piston movable within a cylinder and a connecting rod extending therefrom. One or more arms extend from each of the connecting rods, the arms are each guidably and rotatably restrained by a substantially spiral shaped and curved pattern defined within a unit housing. Each connecting rod terminates in an axially open and interiorly hollowed sleeve which is axially reciprocated and rotated. A unit shaft includes an upper end journaled within the associated sleeve. The sleeve is independently axially reciprocatable, while rotatably constrained to the associated unit shaft. The unit shafts each connect to an opposite facing side of a sub-assembly gear, through an associated clutch and/or synchronization system. A main gear and, optionally, intermediate transition gears are operatively engaged with the sub-assembly gear and in turn drive a main gear and main shaft of the engine.

### CROSS REFERENCE TO RELATED APPLICATIONS

The present invention claims priority from and is a continuation-in-part of U.S. Provisional Application Ser. No. 60/241,062, filed Oct. 17, 2000, for a Combustion Engine.

### BACKGROUND OF THE INVENTION

1. Field of the Invention

The present invention relates generally to internal combustion engine designs. More specifically, the present invention discloses a novel internal combustion engine featuring one or more sub-assemblies. Each sub-assembly is defined by a pair of axially arrayed and opposing units, such including a piston movable within a cylinder and a connecting rod extending therefrom. Each sub-assembly includes a mechanism to convert the reciprocation of each piston into a continuous rotation of an output shaft. The invention provides significant improvements over contemporary engine designs, including smaller size and weight (than associated with other existing engines with similar power ratings), quieter and cleaner operation, and increased power and fuel efficiency. Yet additional features provided by the engine design of the present invention include the reduced part content and selective upgrade-ability or downgrade-ability (by combining in duplicating fashion any number of pairs of opposing and axially aligned units) for both smaller passenger vehicles and larger sized trucks.

2. Description of the Prior Art

The prior art is well documented with numerous examples of alternately configured internal combustion engines. The attempt in each instance is to devise an optimal piston and cylinder arrangement for a given output application.

A first example of the prior art is set forth in U.S. Pat. No. 2,962,008, issued to Hopkins, and which teaches a simplified four cycle engine, devoid of valves or cranks, and which rather employs a flywheel arrangement mounted on a driven shaft for varying the speed of the engine. It is noted however that Hopkins provides not teaching or suggestion as to how inherent forces existing in the design are to be balanced.

U.S. Pat. No. 1,572,068, issued to Gould, teaches a two cylinder engine design in which the cylinders are horizontally disposed in an in-line formation. A double acting piston is arranged in each cylinder and interconnecting rods transmit a revolving movement to the pistons and cylinders in unison about their longitudinal axis. It is again however noted that Gould does not teach or suggest any means for balancing the internal forces existing within the dual cylinder arrangement, in fact it would appear that the manner in which the pistons engage the cylinders would tend to create significant eccentric or inertial forces within the engine. Furthermore, no means is suggested or taught for upgrading the capability of the design for larger sized applications.

U.S. Pat. No. 855,256, issued to Morey, discloses an IC engine design in which the reciprocation of a piston (or pistons) is converted into the rotation of a shaft by means of a drum, having a continuous encircling cam groove, and a roller journaled upon a pin attached to the piston and engaging the groove. Morey again includes a pair of co-axial and two cycle cylinders, the respective strokes of which act in a same direction upon a piston or connected piston heads and so that two pulses are imparted at each revolution. A distinctive shortcoming of such axially arrayed designs is the inherent eccentric forces, and which result from the alternating piston strokes. As again has been referenced in regards to other prior art references, the Morey design does not suggest or accommodate upgrade-ability by permitting combination of identically constructed and individual pairs of opposing cylinders and it is also noted that U.S. Pat. No. 4,274,327, issued to Olsgaard, is a similar variation of the Morey design.

Finally, U.S. Pat. No. 1,005,763, issued to Adams, discloses a yet further engine variation in which a piston stroke defines a longitudinal range, while at the same time imparting a rotary motion and due to a unique spiral arrangement established between the piston and cylinder. It is noted that the shaft in Adams extends the entire way through the cylinder, thus resulting in a significantly oversized piston. As such, the inherent shortcomings of the prior art, in specific regard to balancing out the various internal forces of the engine design, is once again not addressed in this disclosure.

### SUMMARY OF THE PRESENT INVENTION

The present invention is a novel internal combustion engine assembly, and which combines the ability of providing a single pair (or multiple combinable pairs) of axially opposing units incorporated into an engine assembly for driving a motor vehicle. A unique aspect of the invention is the ability to impart a continuous rotation from a reciprocating cylinder piston to an output sub-assembly shaft and main engine shaft in an axial direction. In most prior art applications, the main engine lies in a perpendicular arrangement relative to the direction of the individual pistons.

As previously described, key advantages of the present engine design include the reduced size (typically 40% smaller weight than for existing engines with the same power output), and reduced noise level and vibrations generated by the engine. Additional advantages of the invention include increased efficiency, durability, cleanliness of operation, and reliability.

As also previously described, key operating advantages of the present engine design include the substantial elimination of engine forces, again resulting from the synchronous opposing strokes of the paired pistons, tending to cancel each other out. It is also contemplated that the stroke cycles of the pistons, of the opposing cylinders (forming portions of the axially disposed units) may be synchronized both with respect to each other as well as to cycles of additional pistons in cylinders which form portions of additional subassemblies.

Further provided is the ability to combine, or string together, in a single operating arrangement any plurality of individual unit pairs (sub-assemblies). The further advantage of stringing together a number of sub-assemblies is to selectively upgrade or downgrade the capability of the custom assembled engine arrangement to a range of applications extending between smaller passenger sized vehicles and larger sized trucks and other work-type vehicles. As previously described, a suitable synchronizer assembly is provided for ensuring proper piston/connecting rod engagement of each associated unit and engagement to an output sub-assembly gear positioned between an opposing pair of units. Such an electronic, mechanical, or other synchronization system may further include an appropriate combination of clutch(es) and other system components for engaging/disengaging individual sub-assembly pairs of units, or even individual units.

As discussed, the internal combustion engine consists of one or more individual pairs of units, each pair forming a part of a separate sub-assembly and so that each individual pair of units is arranged in axially spaced and opposing fashion. Each of the unit pairs further includes opposing pistons and extending connecting rods which extend from their respective cylinders and in converging fashion towards one another.

One or more arms extend from each of the connecting rods and terminates in singular or multiple roller or sliding shoe or other arrangements which are in turn guidably and rotatably restrained by a substantially spiral shaped and curved pattern defined within a housing of the sub-assembly. The curved pattern in turn includes either a projecting or recessed rail for guidably restraining the associated extending arm end.

Each connecting rod terminates in a downwardly open and interiorly hollowed sleeve (optionally a shaft or bar) which is both axially reciprocated and rotated. A sub-assembly shaft, associated with each of the opposing pairs of units, includes an upper end journaled within an associated sleeve. In another embodiment, the sub-assembly shaft ends with the hollowed sleeve journaled with the end of the connecting rod, such again being a bar or shaft. Upon activation of the sub-assembly, corresponding to succeeding unit cycles or piston strokes, the sleeve is independently axially reciprocatable, while at the same time rotatably constrained to the associated unit shaft and so as to impart a continuous rotation to the sub-assembly gear.

The unit shafts each connect to an opposite facing side of a sub-assembly gear, through a clutch and/or suitable electronic, mechanical, or other synchronizing mechanism, the sub-assembly gear again being associated with a given engine sub-assembly. A main gear is operatively engaged with the sub-assembly gear and in turn drives a main drive shaft of the engine.

In a further variant, the unit shaft terminates in such a way that it contains a spiral shaped and curved pattern. In this instance, the connecting rod includes two sets of arms, one of which constrains the rotational motion of the connecting rod (constraining arms). The other arms engage the spiral curve shape attached to the unit shaft.

Additional variations of the invention contemplate one or more sub-assembly gears, associated with one or more sub-assemblies, engaging directly with the main gear/shaft of the engine. Other alternate variants contemplate inserting transition gears to interconnect the sub-assembly gears with the main gear/shaft of the engine.

A further variant of the invention contemplates arranging the spiral shaped and curved pattern directly within the cylinder head, the cylinder further including a pair of spaced apart and upper and lower pistons. The connecting rod extends between the pistons and further axially from the cylinder. One or more arms extend from the connecting rod, within the cylinder and between the spaced apart pistons, and are guidably restrained by the spiral and curved pattern defined directly within the interior wall of the cylinder.

An axially extending and open end sleeve, or as previously stated can also be a shaft/bar, is fixedly secured to the connecting rod. As with the earlier embodiment, an upper end of the unit shaft, associated with each unit, includes an upper end journaled within the associated sleeve. Upon activation of the engine, corresponding to succeeding piston strokes or unit cycles, the sleeve is independently axially reciprocatable while at the same time rotatably constrained to the associated unit shaft, to continuously rotate the unit shaft, and in turn actuate the sub-assembly gear and engaging main gear and/or transition gears.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is a frontal view, in selected cross section, and illustrating first and second individual pairs of axially disposed and opposing sub-assembly units, each unit having a piston moveable within a cylinder and a connecting rod extending therefrom, according to a given embodiment of the present invention;

FIG. 2 is an enlarged sectional view of a given unit (including piston and cylinder), such as that also shown in FIG. 1, and further illustrating in additional detail the manner in which the reciprocating motion of a connecting rod of the piston is converted, by virtue of the spirally shaped and curved pattern cam rail and combined axially reciprocatable and rotatable sliding tube or sleeve, into the rotational output of the sub-assembly shaft;

FIG. 3 is an enlarged sectional view of an alternate variant of the piston and cylinder variant, according to a given sub-assembly unit included in the present invention, and in which a pair of spaced pistons are located within the cylinder and in combination with a spirally shaped and curved pattern, performs the eccentric to rotational motion conversion within the cylinder itself and imparts the continuous rotation to the unit shaft and sub-assembly gear;

FIG. 4 is a sectional view of an alternative rotating arm arrangement, as compared to that previously illustrated in FIGS. 1 and 2, and in which a pair of opposing and configured sliding shoes abut against opposite faces of a projecting spirally shaped and curved pattern;

FIG. 5 is a sectional view of a yet further alternative rotating arm arrangement and in which a pair of rollers are located inside an inwardly recessed variant of the spirally shaped and curved pattern;

FIG. 6 is a sectional view of an additional alternate rotating arm arrangement in which a single roller is disposed inside the recessed spirally shaped and curved pattern established in the spiral and curved pattern shape;

FIG. 7 is a sectional view of a still further rotating arm arrangement, similar to that previously shown in FIG. 4, and in which configured shoes are arranged in opposite facing and channeled fashion within the spirally shaped and curved pattern;

FIG. 8 is an illustration of a gear configuration for effecting power transmission from a plurality of encircling sub-assembly gears and shafts to a main gear and shaft;

FIG. 9 is an alternate gear configuration in which a plurality of individual sub-assembly drive shafts transfer power to intermediate transition gears and, ultimately, to a main gear and engine shaft;

FIG. 9A is a further alternate gear configuration incorporating unit sub-assembly gears, transition gears, and a main gear according to the present invention;

FIG. 10 is a two-dimensional graphical depiction, corresponding to an unfolded three-dimensional spirally shaped and curved pattern of a selected rail/groove, and which evenly spaced cycles are indicated for the suction, compression, power delivery and exhaust cycles of the unit;

FIG. 11 is a graphical depiction, similar to that of FIG. 10, and further illustrating a modified spirally shaped and curved pattern in which the suction, compression, and exhaust cycles are reduced in favor of extending the power delivery stage;

FIG. 12 is a sectional view of an alternate variation of the piston and cylinder arrangement and which shows one of many possible internally extending and lubricating/cooling channels;

FIG. 13 is a sectional view of an alternate variation of a sliding tube and rotating shaft and which shows a possible solution for connecting lubricating/cooling channels between the unit shaft and hollowed sleeve of the connecting rod;

FIG. 14 is a cutaway illustration of an alternate configuration of the connecting rod, axially reciprocating and rotating sleeve, and extending arms and which illustrates three arms at different elevations; and

FIG. 15 is a schematic of an arrangement of any three extending arms, such as those illustrated in FIG. 14, at given angular offsets, it being understood that any number of extending arms can be employed, from one arm to any increased plurality and at any elevation or angular offset.

### DETAILED DESCRIPTION OF THE PREFERRED EMBODIMENTS

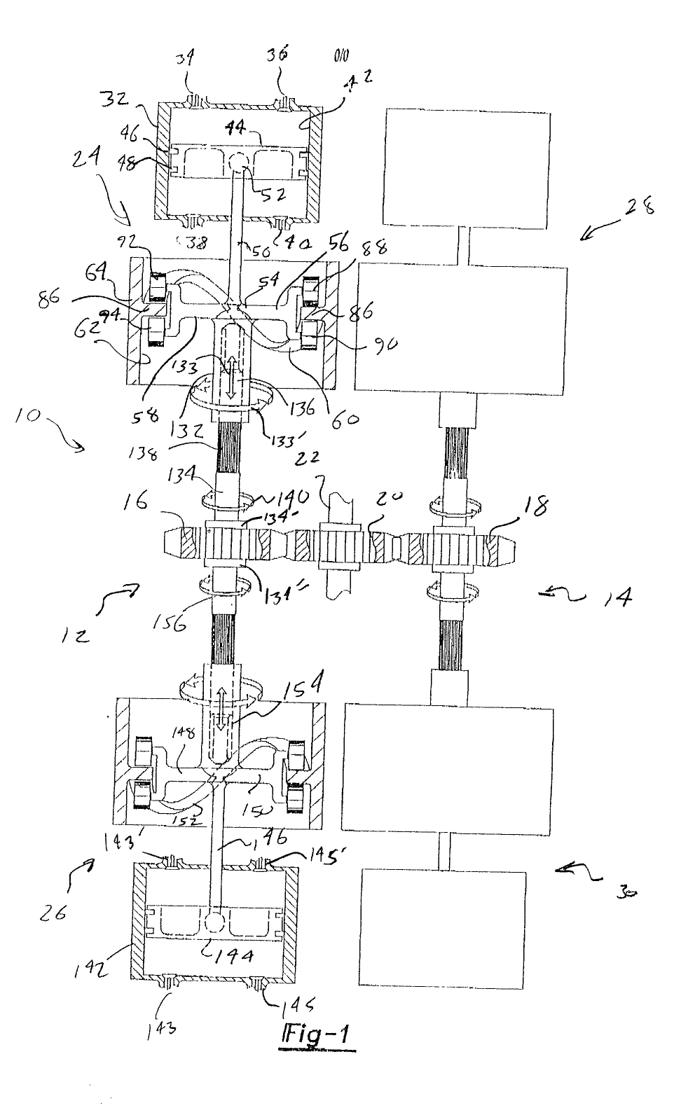

Referring to FIG. 1, an internal combustion engine design is illustrated at 10 according to a preferred embodiment of the present invention. As previously described, the engine design of the present invention combines the ability of providing (in an opposing and preferential application) a single pair (or multiple combinable pairs) of axially opposing and synchronously actuating units (cylinder tandems) for driving an engine, such as stationary or employed in any powered land, sea or air craft. As also previously described, key advantages of the present engine design include the reduced size (typically 40% smaller weight than for existing engines with the same power output) and noise and vibration level, and increased efficiency, durability, reliability and cleanliness of operation.

Other additional advantages of the present engine design include the substantial elimination of engine forces, again resulting from a variant in which the opposing strokes of the paired pistons are synchronized to each other. In this instance, the forces tend to cancel each other out. Other advantages include the ability to combine, or string together in any given operating arrangement, any number of individual unit pairs. A suitable synchronizing mechanism (typically an electronic or mechanical unit or module) engages clutch mechanisms associated with the unit/sub-assembly and to engage or disengage given sub-assembly or even an individual unit. The further advantage of the ability to engage/disengage multiple sub-assemblies or individual units is to selectively upgrade or downgrade the capability of the custom assembled engine arrangement to a range of applications extending between smaller passenger sized vehicles and larger sized trucks and other work-type vehicles. It is also understood that design components of each unit can be normalized and so that the size of normalized components can remain constant for both downsized and upsized engine outputs.

Referring again to FIG. 1, the illustration 10 is of a first sub-assembly pair of opposing and axially arrayed units 12 (in solid illustration and cutaway) and a second like sub-assembly pair of units 14 (largely schematically represented). Each of the opposing and individual sub-assemblies 12 and 14 further include a sub-assembly gear, see 16, for sub-assembly 12 and sub-assembly gear, see 18 for sub-assembly 14. In the variant 10 illustrated in FIG. 1, the sub-assembly gears 16 and 18 engage a main gear 20 forming a part of a main drive shaft 22 of the engine. As will be explained with reference to future preferred embodiments, a wide range of varying arrangements is made possible by the engine design of the present invention, in particular the ability to stack or replicate identical numbers of the pairs of units, each again corresponding to one sub-assembly and ranging from one to a large multiple of sub-assemblies in order to power vehicles or other machinery of varying size.

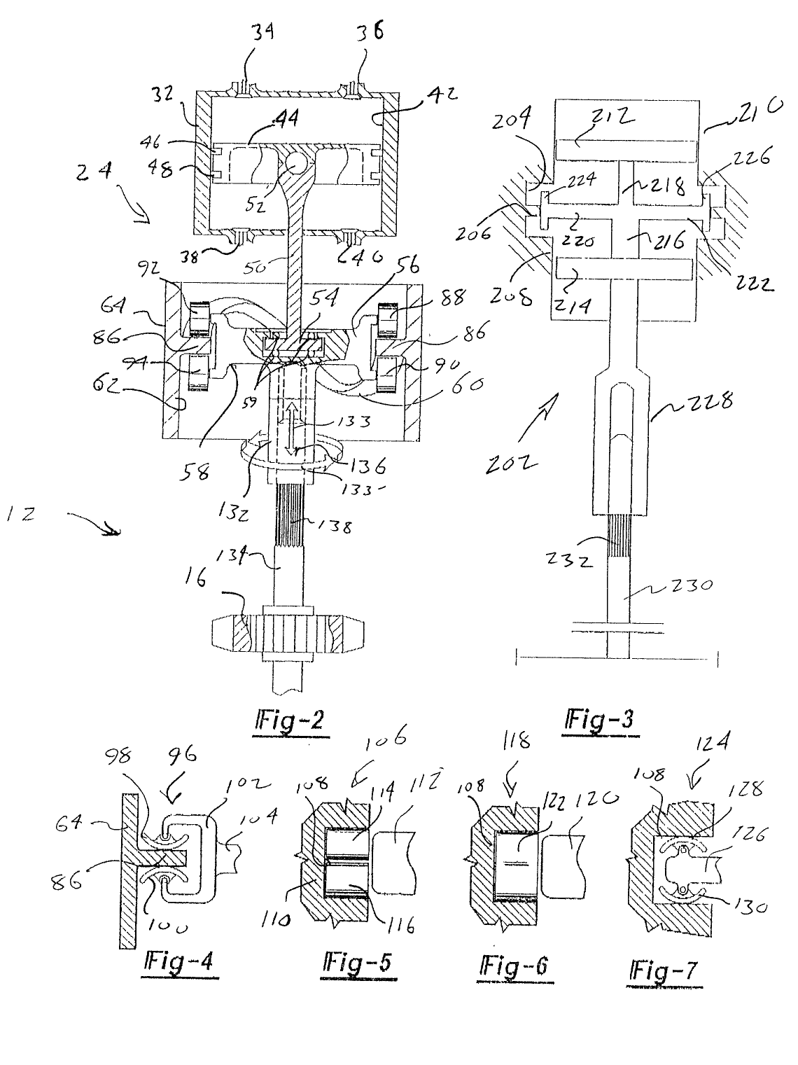

Referring again to FIG. 1, as well as to the enlarged sectional view of FIG. 2, a more detailed explanation will now be given as to the operation of a single unit (or half of a selected sub-assembly). As illustrated in FIG. 1, individual unit assemblies are illustrated at 24 and 26 for the first overall sub-assembly 12, likewise individual unit assemblies are illustrated at 28 and 30 for the second overall sub-assembly 14. While a detailed description may be given as to one opposing side only of a given engine sub-assembly, it is understood that the opposing unit configuration in many instances is identical and that, in every situation, an identical description of the mirror image unit is not necessary.

In any event, and referring also to the enlarged illustration, in FIG. 2, the first unit 24 of sub-assembly 12 includes a substantially enclosed and interiorly open cylinder 32. Reference is further made to inlet valves and outlet valves, one feasible arrangement being shown by inlet valves 34 and 38, and outlet valves 36 and 40, it being understood that any number of valves and valve configuration can be employed. Further, as to the piston 44, it is understood that combustion can occur on either or both sides of the piston.

Enclosed within the cylinder 32, and established between an annular extending and inwardly facing cylindrical side wall 42, is a piston 44. The piston 44 typically includes seals or rings, or set of seals and rings 46 and 48, or other suitable means for sealing opposite sides of the piston 44 during normal or axially reciprocatable motion of the piston 44 corresponding to the unit cycles. It is understood that any combination of seals/rings can be used in the invention.

A connecting rod 50 includes an upper end 52 engaged with the piston 44 and so that the connecting rod 50 is rigidly or rotatably connected with the piston in reciprocating fashion. Variations of the connection include the piston and connecting rod having any type of relative rotation with respect to the axes of the cylinder 32. It is further contemplated that the rotation may occur at either end of the connecting rod 50, such further including the use of bearings or other suitable structure.

A lower end 54 of the connecting rod 50 is likewise secured, in axially reciprocating and, optionally, rotatingly constrained fashion, to a pair of arms 56 and 58 extending in any fashion from the connecting rod 50. As discussed previously, any number of extending arms can be employed in any configuration and it is also understood that 54 can reference either structure associated with the lower end of the connecting rod 50 or the associated arms 56 and 58.

The extending arms 56 and 58 and are guidably restrained within a substantially three-dimensional spiral shaped and curved pattern 60 defined within an inwardly facing surface 62 of a housing portion 64 associated with unit 24. Without limitation, the spirally shaped and curved pattern can be sinusoidal in shape, or provided with any configuration according to one skilled in the art.

It is further contemplated that the minor rotational and translational misalignments may occur between the lower end 54 of the connecting rod 50 and the oppositely extending arms 56 and 58. The similar phenomenon may occur between connecting rod 50 and piston 44. To combat such potential misalignments, additional structure may be incorporated into the connection between the end 54 and the arms 56 and 58, and such may include bearings (see at 59 in FIG. 2) or mechanism to compensate for small offsets between the end of the connecting rod 54 and rotating arms (not shown). The objective of the bearing or bearings is to allow relative rotation between the arms and connecting rod, while at the same time the relative reciprocal motion between the arms 56 and 58 and connecting rod 50 is constrained. The objective of the mechanism is to allow for small misalignments between the connecting rod 50 and rotating arms 56 and 58.

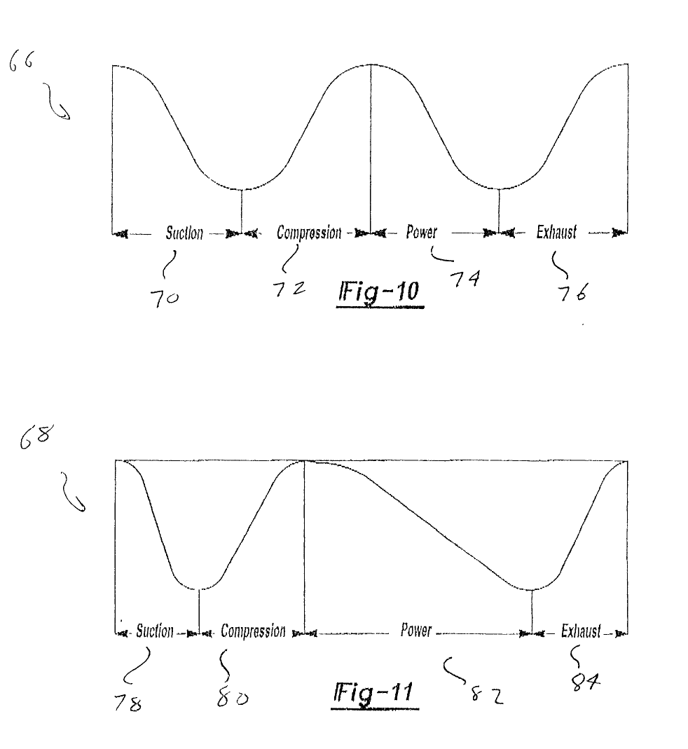

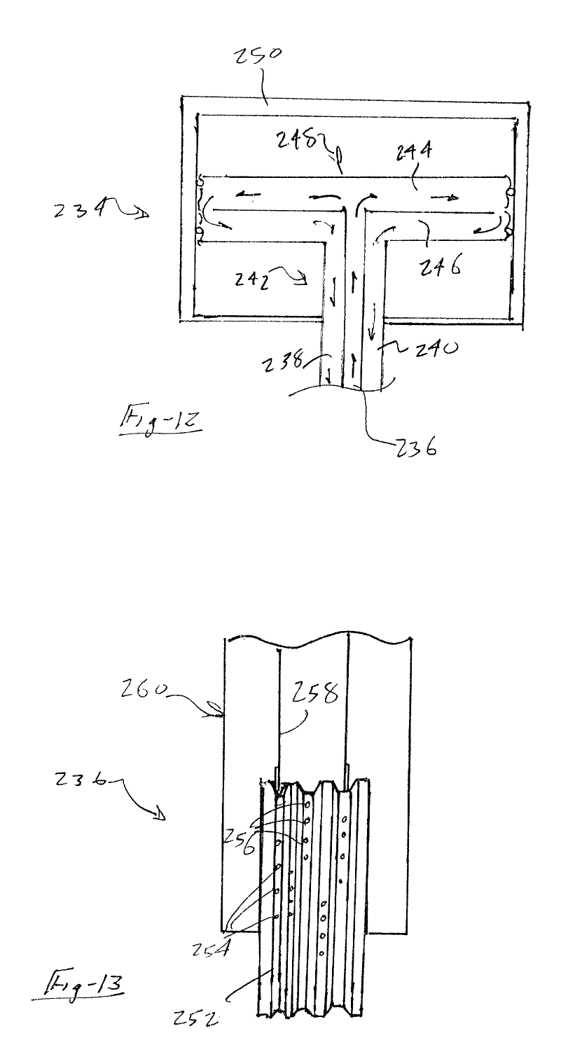

Prior to giving a more detailed description of the structural aspects associated with the spirally shaped and curved pattern 60 illustrated in FIGS. 1 and 2, reference is made to FIGS. 10 and 11, and which establish respective graphical two-dimensional depictions (at 66 for FIG. 10 and at 68 for FIG. 11) corresponding to the stroke cycles of each unit. Referring first to the graphical illustration 66 of FIG. 10, a series of continuous and repeating cycles of even spaced rotational distance are generated by the two-dimensional depiction of the spirally shaped and curved pattern 60 and include suction 70, compression 72, power 74 and exhaust 76 cycles of the unit piston. The two-dimensional graphic description of FIG. 10 contemplates the unit cycles, which generate substantially identical rotational distance.

Referring again to FIG. 11, the alternative two-dimensional graphical depiction of spirally shaped and curved pattern 68, illustrates cycles which generate unequal rotational distances of the unit shaft. As seen in FIG. 11, 78 refers to suction, 80 to compression, 82 to power delivery, and finally, 84 to exhaust. It is also understood that the two cycles occur in two-cycle engines and four such cycles in four-cycle engines, the present invention capable of being applied to either two or four-cycle engines.

It is also understood that each cycle can generate a different rotational length of the unit shaft and that FIG. 11 represents an elongated power cycle, as it is currently understood that doing so will maximize the power efficiency and cleanliness of operation (reduced toxins in exhaust gases) of the unit. However, it being understood that the given and repeating stages of the spirally shaped and curved patterns 78, 80, 82 and 84 may be manipulated, by shortening or lengthening each respective stage (such as again by increasing or decreasing its rotational distance/slope).

Referring back to FIGS. 1 and 2, the spirally shaped and curved pattern 60 is additionally illustrated in structural and two-dimension cutaway, at 86, as a spiral and curved pattern shaped rail extending within the housing portion 64. The extending arms 56 and 58 in the illustrated variant of FIGS. 1 and 2 each terminate in a pair of rollers, see at 88 and 90 for arm 56 and at 92 and 94 for arm 58. It is understood that any number of rollers (or other means of following the spirally shaped and curved patterns) can be used without any limitation. The individual pairs of rollers 88 & 90 and 92 & 94, are spaced from each other incremental distances and engage opposite facing surfaces of the spirally shaped and curved pattern and projecting rail (60 or 86) to thereby provide the guiding and continuous constraining motion of the arms 56 and 58 as they travel through the four operation cycles of the unit.

Referring to FIG. 4, a sectional illustration is provided, at 96, of a first alternate structural variant of the guiding/restraining structure and which a pair of opposing and configured sliding shoes are associated with each arm. Shoes 98 and 100 are shown in arcuate facing and opposing fashion secured to an end connection 102 of a given extending arm (104). The arcuate surfaces of the shoes 98 and 100 perform a similar function to the pairs of rollers shown in FIGS. 1 and 2, each engage an opposite facing surface of the projecting rail 86 (FIG. 4). Alternately, a single shoe or other multiple shoe arrangement can be substituted.

Referring in succession to FIG. 5, a further sectional illustration 106 is shown of a recessed rail 108, defined within an inner annular surface of the unit housing 110. Each extending arm, illustrated in partial view by arm 112, includes a pair of closely spaced rollers 114 and 116 engaging against opposing top and bottom surfaces of the recessed rail. In the preferred embodiment, the rollers 114 and 116 are in contact with one another such that they roll over one another, to the benefit of increased structural strength.

Referring further to FIG. 6, a further sectional illustration 118 is shown of the recessed rail 108, in this instance again including an extending arm, illustrated in partial view by arm 120, and including only a single roller 122 in close proximity to both the opposing top and bottom surfaces of the recessed rail 108 and so that the desired guidable and restraining aspects are provided to both the associated and extending arms secured to the corresponding end of the given connecting rod.

Referring further to FIG. 7, a sectional illustration 124 is given of a yet further guiding and restraining connection and again includes a recessed rail 108. The extending arms, illustrated by partial view of selected arm 126, included a pair of configured shoes 128 and 130, similar functionally to the pair of shoes previously illustrated at 98 and 100, and in which each of the shoes 128 and 130 are arranged in an opposite facing and channeled fashion to abut against a selected and inwardly facing surface defining the recessed rail 108.

Without limitation, additional structural variants are contemplated for guidably restraining the extending arms 56 and 58 of the connecting rod 50, in both the axially reciprocating and combined rotational motion. It is also understood that, in substitute variants, the construction of the unit can be modified to introduce magnetic or electromagnetic fields between the rail and shoes in order to prevent contact, thus avoiding wearing of the rail and engaging arm(s) structure, to also decrease/eliminate friction, and to improve efficiency. As also known, hydraulic fluid can be used to decrease/eliminate friction again between the rails and the corresponding engaging structure of the arm(s).

The connecting rod 50 further terminates in a downwardly extending and open/hollowed sleeve 132, fixed in a rotational direction but which is still understood to have some compensation mechanism for misalignment in any direction (rotational and/or normal), and such that the sleeve 132 is slaved to the combined reciprocating and rotational motion (see directional arrows 133 and 133′ in FIGS. 1 and 2) created by the extending arms 56 and 58 following the spiral shaped and curved pattern (and in turn caused by the piston 44 stroke of the associated cylinder 32).

In any variant, a sub-assembly shaft, illustrated at 134, includes an upper end 136 journaled within the open end of the sleeve 132. In this fashion, the hollowed sleeve 132 is independently reciprocatable, while at the same time is rotatably constrained to the shaft 134. It is further understood that, as will be additionally described, two unit shafts are provided, one for each associated unit, and which converge to engage the opposite sides of the sub-assembly gear (see again at 16), associated with the given pair of units (24 and 26).

To further assist this structural arrangement, it is contemplated that opposing and axially engaging grooves (see at 138 for upper end 136 of shaft 134) are provided on both the inwardly facing annular surface of the open/hollowed sleeve 132 and the corresponding exterior surface (again at 138) of the unit shaft 134. The grooves permit the hollowed sleeve to independently and axially reciprocate, along the direction of the arrow 133, while at the same time constraining the unit shaft 134 in a rotatable fashion (see arrow 140) which matches the rotational component (arrow 133′) of the reciprocating/rotating sleeve 132.

In a further variant, the journaled relationship between the sleeve and unit shaft is reversed. In this instance, the associated end of the shaft is hollowed (not shown) for receiving, in inserting fashion, a modification of sleeve 132, in this case a solid tubular member with the axial grooves reversed to the outside surface.

As previously described, the above contemplates a detailed description of only one unit, again corresponding to 24 in FIGS. 1 and 2, and it is contemplated that identical structural components are provided for an opposing unit, see again at 26. Specifically, overall components of the second mirrored unit 26 include such identical features as a cylinder 142, inlet valves 143 and 143′ and outlet valves 145 and 145′. Also included in the second unit 26 is an internally actuable piston 144, connecting rod 146, extending arms 148 and 150, spiral shaped and curved pattern 152 (projecting or recessed rail) defined in an associated housing, an axially reciprocating/rotating sleeve 154, and rotatably constrained unit shaft 156. Identical duplicative elements associated with the other engine assemblies 14 (in turn made up of individual and coaxial/opposing units 28 and 30) are again understood to exist and, accordingly, duplicative illustration and description is not necessary.

In order to operationally engage one or more units (24 and/or 26, 28 and/or 30) or sub-assembly (12 and/or 14) to the main engine gear 20 and shaft 22, appropriate synchronization and clutch mechanisms can be employed. In the illustrated embodiment, the unit shaft 134 is connected to sub-assembly gears 16 through a clutch and/or synchronizing mechanism 134′ and as there can be one clutch of one synchronizing mechanism on each side of the sub-assembly gear. The function of the clutch and synchronizers is to engage/disengage the individual units (24 and 26) and (28 and 30) to and from operation of the engine. The function of the synchronizing mechanism is to synchronize the cycles of operation of the individual unit with the operation of the overall engine. In order to operationally function, it is essential that the synchronization mechanism (typically an electronic or mechanical module associated with the engine) determine the location of each piston in the unit cylinder throughout the stroke cycle and in order to establish the correct rotational position for engaging the unit shafts with the sub-assembly gear. Alternatively and/or additionally, the individual units or sub-assemblies are engaged and disengaged from the associated sub-assembly gears at proper rotational alignment between the unit shaft and the sub-assembly gear. The synchronizer and clutch mechanisms and the construction of such an operating synchronizer and clutch is further submitted to be according to the knowledge of one skilled in the art.

An aspect of one preferred embodiment the invention, again previously stated, is the ability of the opposing and individual unit (again referencing pairs 24 and 26, as well as 28 and 30) to conduct their piston strokes and reciprocating/rotating cycles in opposing and unison fashion. An ideal result of this factor is the ability of the units to substantially cancel out the impact forces resulting from each other's cycles.

It is also understood that, with specific regard to multiple unit arrangements, the timing of the individual unit cycles of a given unit (or opposing pair of units) can be modified or altered (in some instances with respect to one another) with the objective of either maximizing the power delivery and/or efficiency of the overall engine assembly (whether including a single pair or multiple number of opposing pairs of units), as well as balancing the inertial forces created on either side of the sub-assembly gear associated with a given pair of units.

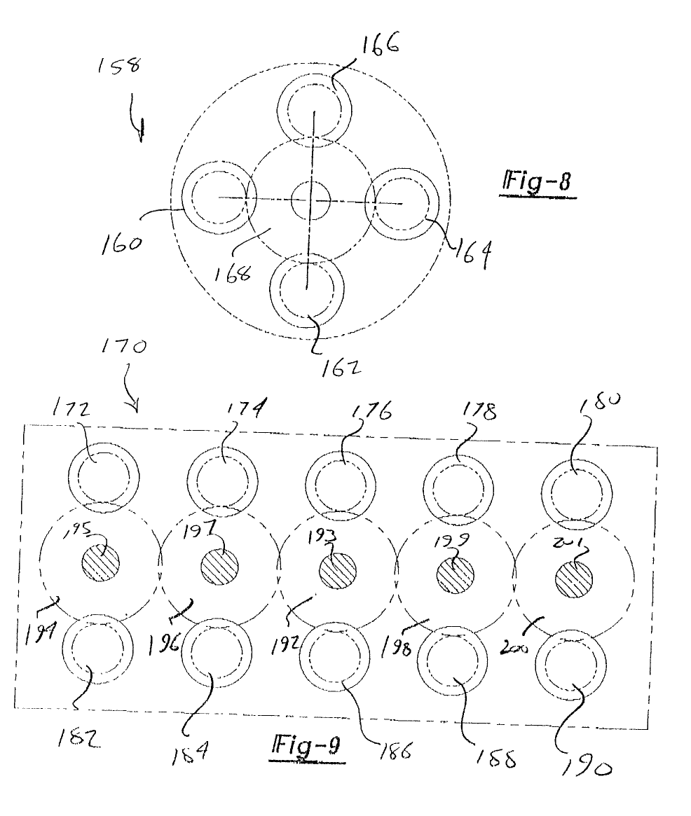

Referring to 158 in FIG. 8, an illustration is given in schematic of one multiple cylinder arrangement and in which a plurality of encircling drive/sub-assembly gears, e.g. at 160, 162, 164 and 166 are provided at interengaging and circumferential locations about a central main engine shaft and gear, e.g. at 168. Each unit gear 160, 162, 164 and 166 corresponds to a given sub-assembly, such as previously described at 12 and 14 in FIGS. 1 and 2, and which includes a pair of opposing and actuable units.

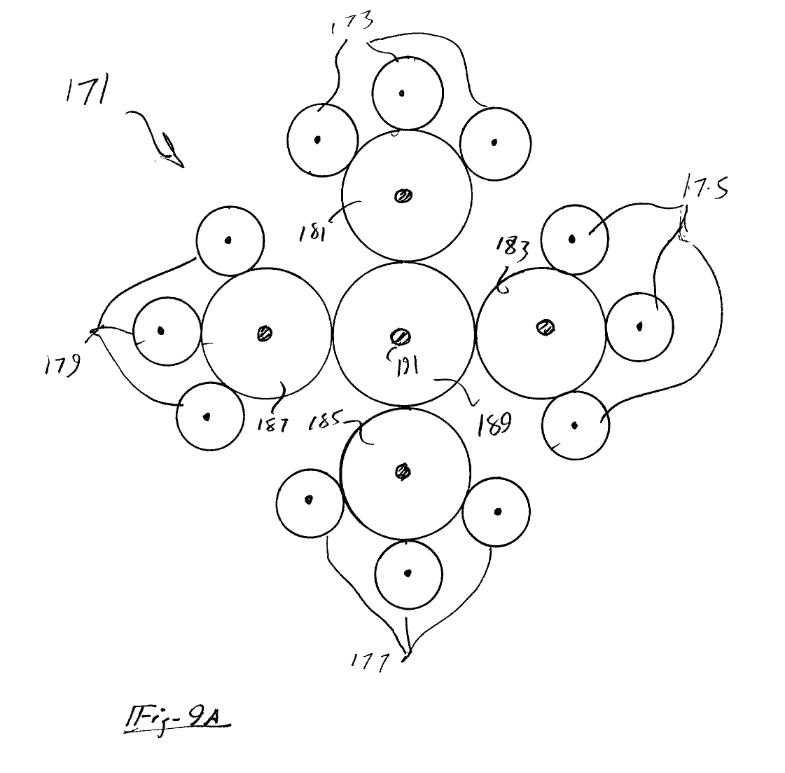

FIG. 9 illustrates, generally at 170, an alternate gear configuration in which a plurality of individual drive or sub-assembly gears/shafts are illustrated at 172, 174, 176, 178 and 180, along one row, and at 182, 184, 186, 188 and 190, along an opposite row. A main gear is illustrated at 192 (see also shaft 193) and a first pair of intermediate transition gears 194 and 196 (shafts 195 and 197) is located on one side of the main gear/shaft 192 and 193 respectively. A second pair of transition gears 198 and 200 (shafts 199 and 201) is likewise located on an opposite side of the main gear 192 (and shaft 193). In theory, the arrangement of FIG. 9, utilizes a total of ten (10) sub-assemblies, and which engage both directly the main gear 192 and, indirectly, through the intermediate transition gears to provide power to the main gear and shaft. As also previously described, a suitable synchronizing and clutch assembly controls the engagement and disengagement of each unit and overall sub-assembly (172-190) to the overall configuration 170.

Referring now to FIG. 9A, a yet further variant 171 of a connection scheme teaches four individual pluralities of three sub-assemblies apiece (e.g. at 173, 175, 177 and 179). Each individual plurality engages, and drives, an associated intermediate transition gear, e.g. at 181, 183, 185 and 187 for sub-pluralities 173, 175, 177 and 179, respectively. The intermediate transition gears in turn engage and operate a main gear 189, again which is associated with a main drive shaft 191 of the engine.

Without limitation, any gear design configuration can be employed, such as may include one or more main shafts (half-shafts) of the engine operated by any arrangement of sub-assemblies and intermediate transition gears. Such may again contemplate driving first and second main and half shafts of the engine (not shown) for respectively operating front and rear pairs of wheels (front and rear axles) of a four-wheel drive land vehicle.

The individual units shown in the examples of FIGS. 8, 9 and 9A can be individually engaged or disengaged, in response to an instantaneous power demand through earlier mentioned unit/sub-assemblies synchronizing mechanisms and/or unit/sub-assembly clutches. In the example of an auto application, during constant speed, e.g. only two base sub-assemblies (such as at 176 and 186) can be engaged to maintain a constant speed of the vehicle. In response to a sudden and instantaneous increase in power demand (for example during acceleration and/or uphill drive), additional units/sub-assemblies can be engaged, the number of sub-assemblies being equivalent to a determined increased power demand. The additional sub-assemblies can be engaged according to any specified preferential sequence such as defined in the controlled system, preferably electronic controller/processor associated with the synchronization and engagement/disengagement of the individual units and unit sub-assemblies through clutch mechanisms.

It is also understood that the base units/sub-assemblies (those necessary to maintain the constant speed) can be rotated among different units/sub-assemblies in operative engagement in the engine. By example, given sub-assemblies 176 and 186 in FIG. 9, which were used for as base sub-assemblies (just to maintain the speed of the vehicle) for certain amounts of operating time or mileage of the vehicle or combination of the above, different sub-assemblies (178, 188) would be used as base sub-assemblies, while 176 and 186 would be deactivated from its function of base sub-assemblies, while still capable of being engaged for providing power in response to increased demand. Such switching would occur after a certain operation time or mileage or combination of the above as determined by the controller associated with the synchronizing system.

Referring to FIG. 3, an alternate illustration 202 is provided of a unit according to a modified variant of the present invention and which includes arranging the spiral shaped and curved pattern, see at 204 and with extending or inward rail 206, directly within an inner annular surface 208 of the associated cylinder 210. The cylinder 210 further includes a pair 212 and 214 of spaced apart and upper and lower pistons, a connecting rod (see portions 216 and 218) extending between the spaced apart pistons 212 and 214 and downwardly from the cylinder along the cylinder axis.

Any number of arms, such as again illustrated by a pair of arms 220 and 222, extend from the connecting rod (216, 218), within the cylinder (210) and between the spaced apart pistons (212 and 214). The arms are guidably restrained by the spiral curve shaped pattern 204 defined directly within the interior wall of the cylinder. As previously described with reference to the earlier disclosed variants, any number of projecting or recessed rail configurations may be employed with either sliding shoes or rollers (singular or plural) and accordingly the illustration of FIG. 3, only generally illustrates abutting portions 224 and 226 associated with the extending ends of the arms 220 and 222.

A downwardly open and interiorly hollowed sleeve 228 is fixedly secured to the extending end of the connecting rod. As with the earlier described embodiment, an upper end of a unit shaft 230 converges on a common sub-assembly gear (not shown), and includes such as extending grooves 232 to permit the shaft to be journaled within the associated sleeve 230 in both independent axial reciprocation and slaved/constrained rotational fashion.

As again previously described, a mirror unit is provided on an opposite side of an associated sub-assembly gear (again not shown). Upon activation of the sub-assembly corresponding to succeeding unit piston strokes, the sleeve is independently axially reciprocatable, while at the same time rotatably constrained to the associated unit shaft. The rotation of the unit shaft in turn actuates the common sub-assembly gear and thereby engages the main gear and/or transition gears. As also described previously, the configuration of the sleeve and sub-assembly shaft can be reversed, so that the portion identified at 228 can be configured to journal inside an open end of a reconfigured unit shaft 230.

A further variation (not shown) contemplates constructing the unit with two sets of arms. First constraining arms which may extend from the connecting rod and reciprocate, without rotation, while second extending propelling arms (terminating in rollers or shoes) are constrained/engaged to a spiral shaped and curved pattern which forms a part of the actual unit shaft. Because the constrained arms are limited to reciprocating motion only, the propelling arms (rotationally constrained and connected with the connecting rod) would propel the unit shaft through the spiral shaped and curved pattern. As mentioned earlier, this spiral shaped and curved pattern would be an integral part of the unit shaft end.

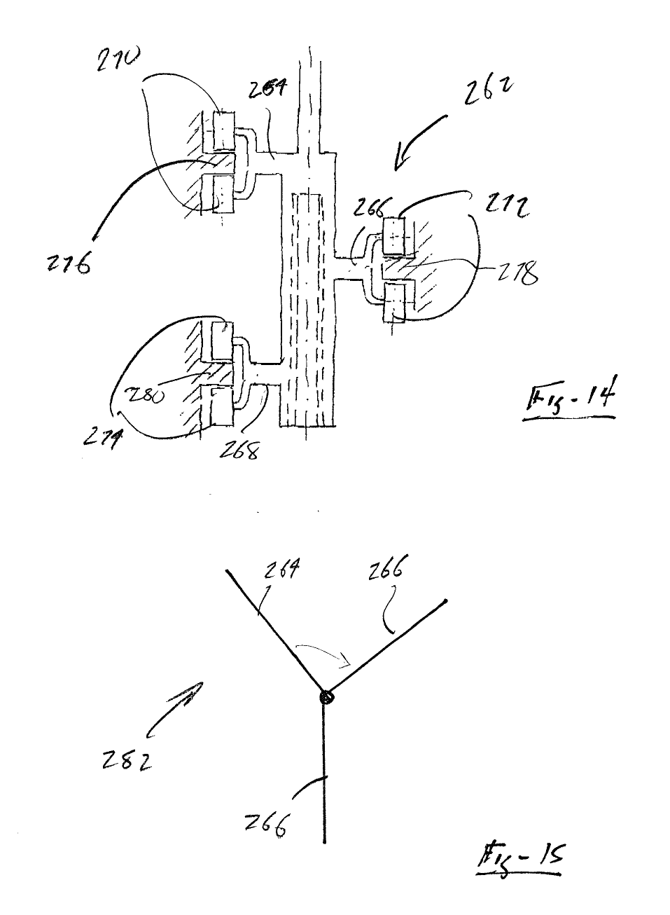

Referring to FIGS. 12 and 13, additional variants are illustrated at 234 and 236 of alternate and additional lubrication variants of the unit piston in the unit cylinder. By example, FIG. 12 illustrates, again at 234, internal lubricant/coolant channels (inlet 236 and outlets 238 and 240) extending from the connecting rod 242 and which intercommunicate with inlet 244 and outlet 246 paths traveling internally through the piston 248, in turn routed through spaces extending between the piston and cylinder 250.

The primary purpose is to provide the piston with the coolant/lubricant which flows from the shaft, through the sleeve, through the connecting rod to the piston. By specially arranging holes in the sliding tube and shaft, a continuous flow of lubricant/coolant is ensured from the channels in the unit shaft to channels in the connecting rod, as well as to the piston. Alternately, a hydraulic accumulator (not shown) can be used to accommodate extra fluid volume generated by relative reciprocal motion between the unit sleeve and assembly shaft.

Referring to FIG. 13, the illustration 236 generally shows possible lubrication channels (or in this case pluralities of apertures) defined between the upper associated end of unit shaft 252 (see pluralities of apertures 254, 256, et. seq.) and the internally hollowed surfaces 258 of the reciprocating and rotating sleeve 260. The purpose of some of these channels is to provide proper alignment between openings of the channels in the sleeve and openings of channels in the unit shaft and thus ensuring a continuous and uninterrupted flow of coolant/lubricant to the unit piston through channels in the connecting rod. Additionally, some of these channels provide lubricants from between the hollow sleeve and unit shaft.

Referring to FIG. 14, a cutaway illustration 262 shows an arrangement of three rotating arms 264, 266 and 268 extending from a connecting rod and integrally defined sleeve. As in earlier variants, rollers (see at 270, 272 and 274, respectively) extend from the arms 264, 266 and 268 and are guided along spiral and curved shaped rail patterns 276, 278 and 280 respectively. Without limitation, the illustration 262 shows the arms 264, 266 and 268 at different elevations to thus to enable uneven cycle placement. See again also FIGS. 10 and 11 by example. Also, the design can be modified for both lesser or greater numbers of arms within the scope of the invention.

Finally, FIG. 15 illustrates, schematically at 282, distribution of the arms 264, 266 and 268 from a top view of the connecting arm. The arms can be at any given height or angular offset and are illustrated, by example, at substantially equiangular or not necessarily (or 120° angular) offset.

Having described my invention, additional preferred embodiments will become apparent to those skilled in the art to which it pertains, and without deviating from the scope of the appended claims. Namely, the invention also allows for normalization of components for different engine sizes or power ratings. By example, the piston size at 44 could be used in both smaller power output engines and larger power output engines. The only difference would be that larger engines would utilize a greater number of sub-assemblies or units (see again at 12), as previously described.

I claim:

1. An internal combustion engine, comprising:
at least one pair of units arranged in axially spaced and opposing fashion, each of said units including a piston movable within a cylinder and a connecting rod extending therefrom;
a unit shaft operatively connected to each of said unit connecting rods;
a mechanism for converting a reciprocating output of said connecting rod to a continuous rotation of said unit shaft; and
said unit shaft connecting to a side of a sub-assembly gear, a main gear being operatively engaged with said sub-assembly gear by a synchronizing mechanism and in turn operating a main shaft of the engine.

2. The engine as described in claim 1, further comprising a plurality of individual pairs of units arranged in operatively engaging fashion with a main gear associated with said main shaft.

3. The engine as described in claim 2, further comprising a plurality of transition gears interconnecting said sub-assembly gears with said main gear.

4. The engine as described in claim 1, said converting mechanism further comprising:
at least one arm extending from said connecting rod, said arm being guidably and rotatably retrained by a substantially spiral shaped and curved pattern defined within a housing associated with said unit; and
said connecting rod being engaged with said unit shaft so as to be both independently reciprocated and rotatively constrained with said unit shaft.

5. The engine as described in claim 4, further comprising a hollowed sleeve independently reciprocating and rotatively constrained to an upper end of said unit shaft, axially extending and inter-engaging grooves being established between mating surfaces of said sleeve and said unit shaft.

6. The engine as described in claim 4, said spirally shaped and curved pattern further comprising a projecting rail, each of said extending arms further including a pair of rollers, each of said rollers engaging an opposite facing surface of said projecting rail.

7. The engine as described in claim 4, said spirally shaped and curved pattern further comprising a projecting rail, each of said extending arms further including a pair of opposing and configured sliding shoes, each of said shoes engaging an opposite facing surface of said projecting rail.

8. The engine as described in claim 4, said spirally shaped and curved pattern further comprising a recessed rail, each of said extending arms further including at least one roller guidably restrained within an inner annular surface of said housing.

9. The engine as described in claim 8, further comprising a pair of rollers, each of said rollers engaging an opposing surface defining said recessed rail.

10. The engine as described in claim 4, said spirally shaped and curved pattern further comprising a recessed rail, each of said extending arms further including a pair of configured shoes, each of said shoes being arranged in an opposite facing and channeled fashion to abut against a selected and inwardly facing surface defining said recessed rail.

11. The engine as described in claim 4, said substantially spiral shaped and curved pattern further establishing a continual succession of cylinder cycles corresponding to a suction cycle, a compression cycle, a power output cycle, and an exhaust cycle.

12. The engine as described in claim 11, further comprising each of four stages establishing a substantially identical rotational distance traveled by said associated unit shaft.

13. The engine as described in claim 11, further comprising modified stroke cycles in which said suction, compression, exhaust and power output cycles can each be of different length.

14. The engine as described in claim 11, further comprising a plurality of individual pairs of units arranged in operatively engaging fashion with said main gear and main drive shaft.

15. The engine as described in claim 14, further comprising an offset in completion time established in the completion of each stroke cycle of each unit.

16. The engine as described in claim 4, further comprising an eccentric connection established between said connecting rod and said extending arms, said connection permitting small rotational and translational misalignments occurring between said rod and said arms.

17. The engine as described in claim 1, further comprising internally extending and lubricating channels established within said pistons and connecting rods associated with each of said units.

18. The engine as described in claim 4, further comprising a plurality of lubrication channels established between said hollowed sleeve and said units.

19. An internal combustion engine, comprising:
a plurality of individual pairs of units, each of said pairs of units forming a separate sub-assembly and so that each individual pair of units is arranged in axially spaced and opposing fashion, each of said unit pairs further including opposing pistons movable within cylinders of the first and second units accordingly, and first connecting rods extending from said cylinders associated with said units;
at least one arm extending from each of said connecting rods, said arms each being guidably and rotatably restrained by a substantially spiral shaped and curved pattern defined within a housing associated with each unit, said connecting rod each terminating in a downwardly open and interiorly hollowed sleeve which is both axially reciprocated and rotated;
a unit shaft associated with each of said individual units, each of said shafts including an upper end journaled within an associated sleeve, said sleeve being independently axially reciprocated while rotatably constrained to said unit shaft, said shafts each connecting to an opposite facing side of a sub-assembly gear, a synchronizing mechanism associated with said unit shaft and with said sub-assembly gear and in turn operatively engaging said unit with said sub-assembly gear for driving a main drive shaft of the engine.

20. An internal combustion engine, comprising:
at least one pair of units arranged in axially spaced and opposing fashion, each of said units further including at least one piston movable within an associated cylinder;
a connecting rod extending from each of said pistons;
force conversion means associated with said cylinder for generating a continuous rotational output of each connecting rod extending from said cylinder;
a unit shaft operatively connected to a unit connecting rod; and
said unit shafts connecting to opposite sides of a sub-assembly gear, a main gear operatively engaged with said sub-assembly gear and in turn driving a main drive shaft of the engine.

21. The engine as described in claim 20, further comprising:
a pair of spaced apart pistons arranged within each associated cylinder head and interconnected by said connecting rod;
a substantially spiral shaped and curved pattern being defined within an inner facing surface of said cylinder, said connecting rod further including at least one extending arm guidably restrained along said pattern; and
said connecting rod terminating in an axially extending and open sleeve, an upper end of said unit shaft being journaled within said open end of said sleeve so that said sleeve is both independently axially reciprocal and rotatably constrained relative to said shaft.

22. An internal combustion engine, comprising:
a single unit;
said unit including a piston moveable within a cylinder and a connecting rod extending therefrom;
a unit shaft operatively connected to said unit connecting rod;
a mechanism for converting a reciprocating output of said unit connecting rod to a continuous rotation of said unit; and
said unit shaft connecting to a side of a unit gear, a main gear being operatively engaged with said unit gear by a synchronizing mechanism and in turn operating a main shaft of the engine.
